(19) United States
(12) Patent Application Publication
(10) Pub. No.: US 2016/0362577 A1
(43) Pub. Date: Dec. 15, 2016

(54) A WATERPROOF AND OXYGEN-ISOLATING SEALING FILM AND PREPARATION METHOD

(71) Applicant: FUZHOU UNIVERSITY, Fuzhou, Fujian (CN)

(72) Inventors: Yuying ZHENG, Fuzhou, Fujian (CN); Ningning CAO, Fuzhou, Fujian (CN); Jinxian LIN, Fuzhou, Fujian (CN)

(21) Appl. No.: 15/121,379

(22) PCT Filed: Jan. 21, 2015
(86) PCT No.: PCT/CN2015/071169

§ 371 Date: Aug. 24, 2016

(30) Foreign Application Priority Data
Sep. 18, 2014 (CN) 201410477153.5

(51) Int. Cl. C09D 123/08; B65D 65/38; C09D 7/12; C09D 5/08; C01B 31/02; C09D 131/04

(52) U.S. Cl. CPC C09D 123/0853; C01B 31/0253; C09D 131/04; C09D 7/1225; C09D 5/084; B65D 65/38; C01B 2202/06; B82Y 40/00

(57) ABSTRACT

This present invention discloses a waterproof and oxygen-isolating sealing film obtained by a process comprising the steps of oxidizing and longitudinally unzipping multi-walled carbon nanotubes (MWCNTs) into graphene oxide nanoribbons (GONRs); preparing functionalized-GONRs by using γ-(methacryloxypropyl) trimethoxy silane as modifier; mixing ethylene-vinyl acetate copolymer (EVA) with the functionalized-GONRs to obtain a pasty liquid, then coating the liquid to obtain a functionalized-GONRs/EVA film.

### FIELD AND BACKGROUND OF THE INVENTION

This present invention, wherein a waterproof and oxygen-isolating sealing film and preparation method thereof are disclosed, belongs to the field of polymer composite films.

Ethylene-vinyl acetate copolymer (EVA) is prepared from nonpolar vinyl monomers and strong-polar vinyl acetate monomers. Compared with polyethylene, the insertion of vinyl acetate monomers makes EVA aging-resistant and non-toxic, and offers lower crystallinity, excellent low-temperature flexibility, surface gloss, and chemical stability. Various currently available EVA films are associated with poor barrier properties for small molecules such as air and water molecules, making such films unable to meet the requirements for application in certain specific areas, such as moisture sealing and corrosion protection for precision instruments, frozen products packaging, and so on. Currently improved EVA films are prepared by melt blending of EVA with organoclay, rectorite, nano-fiber, micro-fiber or other polymers. While such melt blending methods improve EVA's barrier property to certain extent, they suffer from a common disadvantage that the addition of significant amount of other polymers in EVA films affects other properties negatively. The disadvantage significantly limits the applicability of EVA and future development in that direction. As such, to find an effective method to improve the properties of EVA films is a very worthy undertaking.

To improve barrier properties of EVA films, we try to disperse appropriate amount of packing with EVA, which makes gas diffusion-permeation path more zigzag and longer. Graphene is often depicted as a one-layer laminate structure material made of carbon atoms. It has always been a hot research area since it was successfully prepared in 2004. Graphene is impermeable to small molecules (including air and vapor) because of its special structure, which broaden its development in the fields of barrier material. However, it is difficult to batch prepare graphene by existing methods. Graphene also has many wrinkles and fluctuations on the surface which cannot meet the market demand.

A functionalized GONR is an ideal ramification of graphene with good barrier properties. Compared with graphene or oxidized graphene, the functionalized GONRs has higher specific surface area, higher dispersion in organic solvent and less defects, and is more stable to small molecules and easily remoldable and reshapable. These better properties make GONRs more attractive in a broad range of applications as barrier materials against oxygen and vapor.

However, there are still many challenges in preparing composite films from functionalized GONRs and EVA.

### BRIEF SUMMARY OF THE INVENTION

The present invention aims at developing a kind of waterproof and oxygen-isolating sealing film and a preparation method thereof to overcome the disadvantages of the prior art. Because of the interaction between functionalized GONRs and EVA, films prepared by this invention, which have excellent barrier property, acid-base resistance property and mechanical property, could be widely used in sealing films for precision instruments, packs for frozen products, etc.

Thus, what is disclosed here is a kind of waterproof and oxygen-isolating sealing films, obtainable by a process comprising the steps of oxidizing and longitudinally unzipping multiwalled carbon nanotubes (MWCNTs) into graphene oxide nanoribbons (GONRs), preparing functionalized-GONRs by using γ-(methacryloxypropyl) trimethoxy silane as modifier, mixing ethylene-vinyl acetate copolymer (EVA) with the functionalized-GONRs to obtain a pasty liquid, and finally coating the liquid to obtain a functionalized-GONRs/EVA film.

In the above steps, the MWCNTs has a diameter of 40-80 nm, the EVA has a vinyl acetate content of 10 wt %-20 wt % and a melt index value of 1.0-3.0 g/10 min, and the mass ratio of EVA and the functionalized-GONRs in the pasty liquid is in the range of 012-0.24:10-15.

More specifically, the waterproof and oxygen-isolating sealing films synthesis step is carried out according to the following procedure:

Step 1: preparing GONRs, which comprises the following sub-steps:

1a). slowly adding 180-200 mL concentrated H₂SO₄ solution to a round-bottom flask, then adding 20-25 mL 85.5 wt % H₃PO₄ solution dropwise into the flask, mixing the mixture well to obtain a mixed acid solution;

1b). adding 1-1.2 g MWCNTs to the mixed acid solution from (1a), stirring the mixture for 1-2 hours, adding 6-8 g KMnO₄ to the mixture gradually in 0.5-1 hours, and stirring the mixture for 0.5-1 hours;

1c). heating the mixture from (1b) while vigorously stirring it under the temperature of 45-60° C. for 1-2 days, then gradually adding the mixture to 500 mL deionized water, stirring the mixture for 1-2 hours, and cooling it down to room temperature, adding 10-15 mL 30 wt % H₂O₂ solution to the mixture, and stirring it for 2-4 hours;

1d). ultrasonic dispersing of the mixture from (1c) for 0.5-1 hours, adding 100-120 mL 38 wt % HCl solution to the mixture, stirring the mixture for 2-4 hours, then filtrating-washing the mixture by polytetrafluoroethylene microfiltration membrane 4-6 times to obtain the solids, finally freeze-drying the solids to obtain GONRs;

Step 2: preparing functionalized-GONRs, which comprises the following sub-steps:

2a). ultrasonic dispersing of the GONRs from step 1 in 500 mL absolute ethyl alcohol for 1-2 hours, then adjusting the pH to 3-4 with a HCl solution;

2b). ultrasonic dispersing of 2.5-3 g γ-(methacryloxypropyl) trimethoxy silane in 100 mL absolute ethyl alcohol for 20-30 minutes, then gradually adding the dispersions into the dispersion from 2a), stirring the dispersion and allow it to react under the temperature of 60-70° C. for 1-2 days;

2c). centrifugalizing the mixture from 2b), then filtrating-washing the mixture by polytetrafluoroethylene microfiltration membrane 4-6 times with ethyl alcohol and deionized water to remove excess γ-(methacryloxypropyl) trimethoxy silane, finally freeze-drying the solids to obtain functionalized-GONRs;

Step 3: ultrasonic dispersing of functionalized-GONRs in toluene for 1-2 hours, then adding pre-dried EVA into the dispersion, allow it to react under the temperature of 65-75° C. for 24-30 hours to obtain a pasty liquid;

Step 4: coating the pasty liquid from step 3 to obtain a waterproof and oxygen-isolating sealing film.

The films obtained from the above method are being widely used as packaging films for precision instruments, frozen products, and foods.

The present invention offers the following significant advantages:

(1) The compatibility of K-GONRs and EVA is well in our composite films, so K-GONRs could be well dispersed in EVA. Additionally, most laminar K-GONRs are vertically dispersed on the section of composite films. In other words, they are parallel distributed in the EVA composite films. These special structures of multilayer, parallel distribution, and close combination of K-GONRs intercalation and EVA matrix, make the composite films have excellent barrier property, acid-alkali resistance property and mechanical property.

(2) The composite films prepared by our invention are environmentally safe, which could be widely used as packaging films for valuable instruments, frozen products, and foods.

(3) The preparation method is scientifically sound, simple and strongly operational, thus makes it possible to batch prepare EVA composite films, which expands EVA's application, broaden market prospect and create social and economic benefits.

### BRIEF DESCRIPTION OF THE DRAWINGS

The drawings included herein are for the purpose of illustrating the exemplified embodiments and shall not limit the scope of the present invention. Other drawings may be produced by those skilled in the art without creative effort.

FIG. 1 is the sketch of preparation process of GONRs;

FIG. 2 are FE-SEM pictures of MWCNTs, K-GONRs and their dispersion state in EVA composite films: (a) MWCNTs, (b) K-GONRs, (c) EVA composite films with 1.0 wt % of MWCNTs, (d) EVA composite films with 1.0 wt % of K-GONRs.

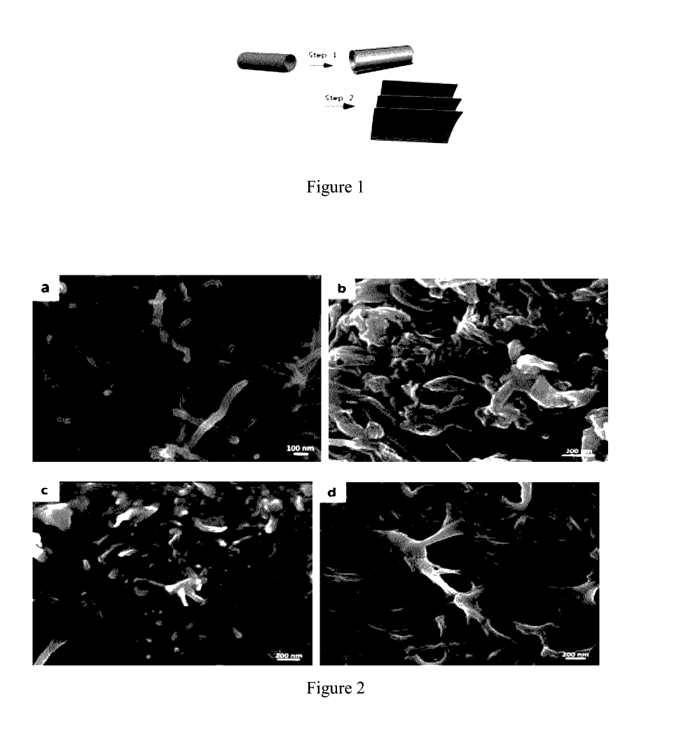

### DETAILED DESCRIPTION OF THE INVENTION

The present invention is further described in the following exemplified embodiments to illustrate the application of the principles of the invention. It is understood that the invention may be embodied otherwise without departing from such principles. The scope of the claims of the present invention expressly should not be limited to such exemplary or preferred embodiments.

### Embodiment 1

This embodiment provides a process for preparing EVA films, comprising the following steps:

Step 1: adding 12 g pre-dried EVA particles into 120 mL toluene (m_{EVA}:Vₜₒₗᵤₑₙₑ=1:10), then let the mixture to react under the temperature of 70° C. for 24 hours to obtain a pasty liquid;

Step 2: coating the pasty liquid from Step 1 onto glass sheets with a coating thickness of 0.06-0.08 mm;

Step 3: placing the glass sheets from Step 2 under room temperature to evaporate the toluene completely to obtain pure EVA films.

### Embodiment 2

This embodiment provides a process for preparing EVA films, comprising the following steps:

Step 1: preparing GONRs, which comprises the following sub-steps:

1a). slowly adding 180 mL concentrated H₂SO₄ solution to a round-bottom flask, then adding 20 mL 85.5 wt % H₃PO₄ solution dropwise into the flask, mixing the mixture well to obtain a mixed acid solution;

1b). adding 1 g MWCNTs to the mixed acid solution from (1a), stirring the mixture for 1 hours, adding 6 g KMnO₄ to the mixture gradually in 0.5 hours, and stirring the mixture for 0.5 hours;

1c). heating the mixture from (1b) while vigorously stirring it under the temperature of 45° C. for 1 days, then gradually adding the mixture to 500 mL deionized water, stirring the mixture for 1 hours, and cooling it down to room temperature, adding 10 mL 30 wt % H₂O₂ solution to the mixture, and stirring it for 2 hours;

1d) ultrasonic dispersing of the mixture from (1c) for 0.5 hours, adding 100 mL 38 wt % HCl solution to the mixture, stirring the mixture for 2 hours, then filtrating-washing the mixture by polytetrafluoroethylene microfiltration membrane 4 times to obtain the solids, finally freeze-drying the solids to obtain GONRs;

Step 2: preparing functionalized-GONRs, which comprises the following sub-steps:

2a). ultrasonic dispersing of the GONRs from step 1 in 500 mL absolute ethyl alcohol for 1 hours, then adjusting the pH to 3 with a HCl solution;

2b). ultrasonic dispersing of 2.5 g γ-(methacryloxypropyl) trimethoxy silane in 100 mL absolute ethyl alcohol for 20 minutes, then gradually adding the dispersions into the dispersion from 2a), stirring the dispersion and allow it to react under the temperature of 60° C. for 1 days;

2c). centrifugalizing the mixture from 2b), then filtrating-washing the mixture by polytetrafluoroethylene microfiltration membrane 4 times with ethyl alcohol and deionized water to remove excess γ-(methacryloxypropyl) trimethoxy silane, finally freeze-drying the solids to obtain functionalized-GONRs;

Step 3: ultrasonic dispersing of 0.012 g functionalized-GONRs in toluene for 1 hour, then adding 12 g pre-dried EVA into the dispersion, allow it to react under the temperature of 70° C. for 24 hours to obtain a pasty liquid;

Step 4: coating the pasty liquid from step 3 to obtain a waterproof and oxygen-isolating sealing film.

The obtained waterproof and oxygen-isolating sealing film has 0.1 wt % K-GONRs.

### Embodiment 3

This embodiment provides a process for preparing EVA films, comprising the following steps:

Step 1: preparing GONRs, which comprises the following sub-steps: 1a). slowly adding 180 mL concentrated H₂SO₄ solution to a round-bottom flask, then adding 20 mL 85.5 wt % H₃PO₄ solution dropwise into the flask, mixing the mixture well to obtain a mixed acid solution;

1b). adding 1 g MWCNTs to the mixed acid solution from (1a), stirring the mixture for 1 hours, adding 6 g KMnO₄ to the mixture gradually in 0.5 hours, and stirring the mixture for 0.5 hours;

1c) heating the mixture from (1b) while vigorously stirring it under the temperature of 45° C. for 1 days, then gradually adding the mixture to 500 mL deionized water, stirring the mixture for 1 hours, and cooling it down to room temperature, adding 10 mL 30 wt % H₂O₂ solution to the mixture, and stirring it for 2 hours;

1d) ultrasonic dispersing of the mixture from (1c) for 0.5 hours, adding 100 mL 38 wt % HCl solution to the mixture, stirring the mixture for 2 hours, then filtrating-washing the mixture by polytetrafluoroethylene microfiltration membrane 4 times to obtain the solids, finally freeze-drying the solids to obtain GONRs;

Step 2: preparing functionalized-GONRs, which comprises the following sub-steps:

2a). ultrasonic dispersing of the GONRs from step 1 in 500 mL absolute ethyl alcohol for 1 hours, then adjusting the pH to 3 with a HCl solution;

2b). ultrasonic dispersing of 2.5 g γ-(methacryloxypropyl) trimethoxy silane in 100 mL absolute ethyl alcohol for 20 minutes, then gradually adding the dispersions into the dispersion from 2a), stirring the dispersion and allow it to react under the temperature of 60° C. for 1 days;

2c). centrifugalizing the mixture from 2b), then filtrating-washing the mixture by polytetrafluoroethylene microfiltration membrane 4 times with ethyl alcohol and deionized water to remove excess γ-(methacryloxypropyl) trimethoxy silane, finally freeze-drying the solids to obtain functionalized-GONRs;

Step 3: ultrasonic dispersing of 0.024 g functionalized-GONRs in toluene for 1 hour, then adding 12 g pre-dried EVA into the dispersion, allow it to react under the temperature of 70° C. for 24 hours to obtain a pasty liquid;

Step 4: coating the pasty liquid from step 3 to obtain a waterproof and oxygen-isolating sealing film.

The obtained waterproof and oxygen-isolating sealing film has 0.2 wt % K-GONRs.

### Embodiment 4

This embodiment provides a process for preparing EVA films, comprising the following steps:

Step 1: preparing GONRs, which comprises the following sub-steps:

1a). slowly adding 180 mL concentrated H₂SO₄ solution to a round-bottom flask, then adding 20 mL 85.5 wt % H₃PO₄ solution dropwise into the flask, mixing the mixture well to obtain a mixed acid solution;

1b). adding 1 g MWCNTs to the mixed acid solution from (1a), stirring the mixture for 1 hours, adding 6 g KMnO₄ to the mixture gradually in 0.5 hours, and stirring the mixture for 0.5 hours;

1c) heating the mixture from (1b) while vigorously stirring it under the temperature of 45° C. for 1 days, then gradually adding the mixture to 500 mL deionized water, stirring the mixture for 1 hours, and cooling it down to room temperature, adding 10 mL 30 wt % H₂O₂ solution to the mixture, and stirring it for 2 hours;

1d) ultrasonic dispersing of the mixture from (1c) for 0.5 hours, adding 100 mL 38 wt % HCl solution to the mixture, stirring the mixture for 2 hours, then filtrating-washing the mixture by polytetrafluoroethylene microfiltration membrane 4 times to obtain the solids, finally freeze-drying the solids to obtain GONRs;

Step 2: preparing functionalized-GONRs, which comprises the following sub-steps:

2a). ultrasonic dispersing of the GONRs from step 1 in 500 mL absolute ethyl alcohol for 1 hours, then adjusting the pH to 3 with a HCl solution;

2b). ultrasonic dispersing of 2.5 g γ-(methacryloxypropyl) trimethoxy silane in 100 mL absolute ethyl alcohol for 20 minutes, then gradually adding the dispersions into the dispersion from 2a), stirring the dispersion and allow it to react under the temperature of 60° C. for 1 days;

2c). centrifugalizing the mixture from 2b), then filtrating-washing the mixture by polytetrafluoroethylene microfiltration membrane 4 times with ethyl alcohol and deionized water to remove excess γ-(methacryloxypropyl) trimethoxy silane, finally freeze-drying the solids to obtain functionalized-GONRs;

Step 3: ultrasonic dispersing of 0.06 g functionalized-GONRs in toluene for 1 hour, then adding 12 g pre-dried EVA into the dispersion, allow it to react under the temperature of 70° C. for 24 hours to obtain a pasty liquid;

Step 4: coating the pasty liquid from step 3 to obtain a waterproof and oxygen-isolating sealing film.

The obtained waterproof and oxygen-isolating sealing film has 0.5 wt % K-GONRs.

### Embodiment 5

This embodiment provides a process for preparing EVA films, comprising the following steps:

Step 1: preparing GONRs, which comprises the following sub-steps:

1a). slowly adding 180 mL concentrated H₂SO₄ solution to a round-bottom flask, then adding 20 mL 85.5 wt % H₃PO₄ solution dropwise into the flask, mixing the mixture well to obtain a mixed acid solution;

1b). adding 1 g MWCNTs to the mixed acid solution from (1a), stirring the mixture for 1 hours, adding 6 g KMnO₄ to the mixture gradually in 0.5 hours, and stirring the mixture for 0.5 hours;

1c) heating the mixture from (1b) while vigorously stirring it under the temperature of 45° C. for 1 days, then gradually adding the mixture to 500 mL deionized water, stirring the mixture for 1 hours, and cooling it down to room temperature, adding 10 mL 30 wt % H₂O₂ solution to the mixture, and stirring it for 2 hours;

1d) ultrasonic dispersing of the mixture from (1c) for 0.5 hours, adding 100 mL 38 wt % HCl solution to the mixture, stirring the mixture for 2 hours, then filtrating-washing the mixture by polytetrafluoroethylene microfiltration membrane 4 times to obtain the solids, finally freeze-drying the solids to obtain GONRs;

Step 2: preparing functionalized-GONRs, which comprises the following sub-steps:

2a). ultrasonic dispersing of the GONRs from step 1 in 500 mL absolute ethyl alcohol for 1 hours, then adjusting the pH to 3 with a HCl solution;

2b). ultrasonic dispersing of 2.5 g γ-(methacryloxypropyl) trimethoxy silane in 100 mL absolute ethyl alcohol for 20 minutes, then gradually adding the dispersions into the dispersion from 2a), stirring the dispersion and allow it to react under the temperature of 60° C. for 1 days;

2c). centrifugalizing the mixture from 2b), then filtrating-washing the mixture by polytetrafluoroethylene microfiltration membrane 4 times with ethyl alcohol and deionized water to remove excess γ-(methacryloxypropyl) trimethoxy silane, finally freeze-drying the solids to obtain functionalized-GONRs;

Step 3: ultrasonic dispersing of 0.12 g functionalized-GONRs in toluene for 1 hour, then adding 12 g pre-dried EVA into the dispersion, allow it to react under the temperature of 70° C. for 24 hours to obtain a pasty liquid;

Step 4: coating the pasty liquid from step 3 to obtain a waterproof and oxygen-isolating sealing film.

The obtained waterproof and oxygen-isolating sealing film has 1.0 wt % K-GONRs.

### Embodiment 6

This embodiment provides a process for preparing EVA films, comprising the following steps:

Step 1: preparing GONRs, which comprises the following sub-steps:

1a). slowly adding 180 mL concentrated H₂SO₄ solution to a round-bottom flask, then adding 20 mL 85.5 wt % H₃PO₄ solution dropwise into the flask, mixing the mixture well to obtain a mixed acid solution;

1b). adding 1 g MWCNTs to the mixed acid solution from (1a), stirring the mixture for 1 hours, adding 6 g KMnO₄ to the mixture gradually in 0.5 hours, and stirring the mixture for 0.5 hours;

1c) heating the mixture from (1b) while vigorously stirring it under the temperature of 45° C. for 1 days, then gradually adding the mixture to 500 mL deionized water, stirring the mixture for 1 hours, and cooling it down to room temperature, adding 10 mL 30 wt % H₂O₂ solution to the mixture, and stirring it for 2 hours;

1d) ultrasonic dispersing of the mixture from (1c) for 0.5 hours, adding 100 mL 38 wt % HCl solution to the mixture, stirring the mixture for 2 hours, then filtrating-washing the mixture by polytetrafluoroethylene microfiltration membrane 4 times to obtain the solids, finally freeze-drying the solids to obtain GONRs;

Step 2: preparing functionalized-GONRs, which comprises the following sub-steps:

2a). ultrasonic dispersing of the GONRs from step 1 in 500 mL absolute ethyl alcohol for 1 hours, then adjusting the pH to 3 with a HCl solution;

2b). ultrasonic dispersing of 2.5 g γ-(methacryloxypropyl) trimethoxy silane in 100 mL absolute ethyl alcohol for 20 minutes, then gradually adding the dispersions into the dispersion from 2a), stirring the dispersion and allow it to react under the temperature of 60° C. for 1 days;

2c). centrifugalizing the mixture from 2b), then filtrating-washing the mixture by polytetrafluoroethylene microfiltration membrane 4 times with ethyl alcohol and deionized water to remove excess γ-(methacryloxypropyl) trimethoxy silane, finally freeze-drying the solids to obtain functionalized-GONRs;

Step 3: ultrasonic dispersing of 0.24 g functionalized-GONRs in toluene for 1 hour, then adding 12 g pre-dried EVA into the dispersion, allow it to react under the temperature of 70° C. for 24 hours to obtain a pasty liquid;

Step 4: coating the pasty liquid from step 3 to obtain a waterproof and oxygen-isolating sealing film.

The obtained waterproof and oxygen-isolating sealing film has 2.0 wt % K-GONRs.

The test results of physical properties of the obtained waterproof and oxygen-isolating sealing films from the above embodiments are shown in Table 1:

| | oxygen | | | |
|---|---|---|---|---|
| | permeation | tensile | | |
| | rate/cm3/ | strength/ | acid resistance | alkali resistance |
| Test items | m2 · d · Pa | MPa | (weight loss ratio/%) | (weight loss ratio/%) |
| Test reference | GB/T1038-2000 | GB/T1040-2006 | corrosive medium: 2 mol/L | corrosive medium: 2 mol/L |
| standard | | | sulfuric acid solution; | sodium hydroxide solution; |
| | | | Corrosion temperature: | Corrosion temperature: |
| | | | room temperature; | room temperature; |
| | | | Corrosion time: 15 days | Corrosion time: 15 days |
| embodiment 1 | 2436.64 | 0.28 | 4.80 | 6.80 |
| embodiment 2 | 2016.37 | 0.35 | 4.27 | 5.87 |
| embodiment 3 | 1744.97 | 0.40 | 3.93 | 4.93 |
| embodiment 4 | 1565.86 | 0.46 | 2.60 | 4.26 |
| embodiment 5 | 1109.44 | 0.53 | 2.07 | 3.87 |
| embodiment 6 | 1680.53 | 0.41 | 1.87 | 3.01 |

As shown in Table 1, the oxygen permeation rate of pure EVA film obtained from embodiment 1 is 2436.64 cm³/(m²·d·Pa), which is significantly higher than the composite films obtained from embodiments 2-6. In other words, the oxygen-isolating property of the composite films obtained from embodiments 2-6 is better than that of pure EVA film. Same conclusion is also applicable to the other properties, such as tensile strength, acid resistance, and alkali resistance. In conclusion, the composite films that are based on functionalized GONRs and EVA have superior water and oxygen barrier properties, acid-alkali resistance property, and mechanical property.

The composite films prepared by this invention are safe to the environment, and may be widely used as packaging films for valuable instruments, frozen products, and foods.

What is claimed is:

1. A waterproof and oxygen-isolating sealing film, obtainable by a process comprising the steps of:
oxidizing and longitudinally unzipping multi-walled carbon nanotubes (MWCNTs) into graphene oxide nanoribbons (GONRs);
preparing functionalized-GONRs by using γ-(methacryloxypropyl) trimethoxy silane as modifier;
mixing ethylene-vinyl acetate copolymer (EVA) with the functionalized-GONRs to obtain a pasty liquid, then coating the liquid to obtain a functionalized-GONRs/EVA film.

2. The film as claimed in claim 1 wherein the MWCNTs has a diameter of 40-80 nm.

3. The film as claimed in claim 1 wherein the EVA has a vinyl acetate content of 10-20 wt % and a melt index value of 1.0-3.0 g/10 min.

4. The film as claimed in claim 1 wherein the mass ratio of EVA and the functionalized-GONRs is in the range of 0.012-0.24:10-15.

5. A process for preparing a waterproof and oxygen-isolating sealing film as claimed in claim 1, comprising the following steps:
Step 1: preparing GONRs, which comprises the following sub-steps:
1a). slowly adding 180-200 mL concentrated H₂SO₄ solution to a round-bottom flask, then adding 20-25 mL 85.5 wt % H₃PO₄ solution dropwise into the flask, mixing the mixture well to obtain a mixed acid solution;
1b). adding 1-1.2 g MWCNTs to the mixed acid solution from (1a), stirring the mixture for 1-2 hours, adding 6-8 g KMnO₄ to the mixture gradually in 0.5-1 hours, and stirring the mixture for 0.5-1 hours;
1c). heating the mixture from (1b) while vigorously stirring it under the temperature of 45-60° C. for 1-2 days, then gradually adding the mixture to 500 mL deionized water, stirring the mixture for 1-2 hours, and cooling it down to room temperature, adding 10-15 mL 30 wt % H₂O₂ solution to the mixture, and stirring it for 2-4 hours;
1d). ultrasonic dispersing of the mixture from (1c) for 0.5-1 hours, adding 100-120 mL 38 wt % HCl solution to the mixture, stirring the mixture for 2-4 hours, then filtrating-washing the mixture by polytetrafluoroethylene microfiltration membrane 4-6 times to obtain the solids, finally freeze-drying the solids to obtain GONRs;
Step 2: preparing functionalized-GONRs, which comprises the following sub-steps:
2a). ultrasonic dispersing of the GONRs from step 1 in 500 mL absolute ethyl alcohol for 1-2 hours, then adjusting the pH to 3-4 with a HCl solution;
2b). ultrasonic dispersing of 2.5-3 g γ-(methacryloxypropyl) trimethoxy silane in 100 mL absolute ethyl alcohol for 20-30 minutes, then gradually adding the dispersions into the dispersion from 2a), stirring the dispersion and allow it to react under the temperature of 60-70° C. for 1-2 days;
2c). centrifugalizing the mixture from 2b), then filtrating-washing the mixture by polytetrafluoroethylene microfiltration membrane 4-6 times with ethyl alcohol and deionized water to remove excess γ-(methacryloxypropyl) trimethoxy silane, finally freeze-drying the solids to obtain functionalized-GONRs;
Step 3: ultrasonic dispersing of functionalized-GONRs in toluene for 1-2 hours, then adding pre-dried EVA into the dispersion, allow it to react under the temperature of 65-75° C. for 24-30 hours to obtain a pasty liquid;
Step 4: coating the pasty liquid from step 3 to obtain a waterproof and oxygen-isolating sealing film.

6. The process as claimed in claim 5 wherein the sealing film from Step 4 has a thickness of 0.06-0.08 mm.

7. The process as claimed in claim 5 wherein the mass ratio of toluene and the pre-dried EVA in step 3 is 10-15:1.

8. The film as claimed in claim 1 that is used as a packaging film for valuable instruments, frozen products, and foods.
